(19) United States
(12) Patent Application Publication
(10) Pub. No.: US 2017/0041429 A1
(43) Pub. Date: Feb. 9, 2017

(54) CACHING NODES

(71) Applicant: HEWLETT PACKARD ENTERPRISE DEVELOPMENT LP, Houston, TX (US)

(72) Inventors: Jonathan GIBSON, Austin, TX (US); Joseph MILLER, Boulder, CO (US); Clifford WILKE, Herndon, VA (US); Scott A. GAYDOS, Emmaus, PA (US)

(73) Assignee: HEWLETT PACKARD ENTERPRISE DEVELOPMENT LP, Houston, TX (US)

(21) Appl. No.: 15/306,557

(22) PCT Filed: Sep. 26, 2014
(86) PCT No.: PCT/US2014/057642

§ 371 Date: Oct. 25, 2016

(51) Int. Cl. H04L 29/08; H04W 4/02; H04W 4/00

(52) U.S. Cl. CPC H04L 67/2852; H04W 4/008; H04W 4/023; H04L 67/26

(57) ABSTRACT

In examples provided herein, upon receiving notification of data to be cached for a package executed in response to a user-initiated experience, where the user-initiated experience originated from a first networked wearable device (NWD) associated with the user, a caching node management engine identifies one or more caching nodes to cache the data and determines available storage resources for each caching node, where each caching node resides at other NWDs associated with the user. The caching node management engine further transmits different portions of the data to the one or more of the caching nodes for caching based upon available storage resources.

### BACKGROUND

In many arenas, disparate tools can be used to achieve desired goals. The desired goals may be achieved under changing conditions by the disparate tools.

### BRIEF DESCRIPTION OF THE DRAWINGS

The accompanying drawings illustrate various examples of the principles described below. The examples and drawings are illustrative rather than limiting.

FIG. 1 depicts an example environment in which a context-aware platform that performs remote management of caching nodes may be implemented.

FIG. 2A depicts a block diagram of example components of a caching node management engine.

FIG. 2B depicts a block diagram depicting an example memory resource and an example processing resource for a caching node management engine.

FIG. 3A depicts a block diagram of example components of a caching node, such as at a networked wearable device or access point.

FIG. 3B depicts a block diagram depicting an example memory resource and an example processing resource for a caching node.

FIG. 4 depicts a block diagram of an example context-aware platform.

FIG. 5A depicts a flow diagram illustrating an example process of identifying and selecting one or more caching nodes at a networked wearable device for caching data for use by a package for providing a user experience. FIG. 5B depicts a flow diagram illustrating an example process of registering networked wearable devices and selecting a caching node at an access point for caching additional data for use by the package.

FIG. 6 depicts a flow diagram illustrating an example process of caching data at a caching node.

FIG. 7 depicts an example system including a processor and non-transitory computer readable medium of a caching node management engine.

FIGS. 8A and 8B depict implementations of example systems including a processor and non-transitory computer readable medium of a caching node.

### DETAILED DESCRIPTION

As technology becomes increasingly prevalent, it can be helpful to leverage technology to integrate multiple devices, in real-time, in a seamless environment that brings context to information from varied sources without requiring explicit input. Various examples described below provide for a context-aware platform (CAP) that supports remote caching node management of one or more caching nodes, hosted at a networked wearable device (NWD) associated with a user or other device in close proximity to a user's networked devices. The user can be a person, an organization, or a machine, such as a robot. The caching nodes provide storage resources that can allow for faster access to data, for example, as used by computationally intense tasks that provide a seamless experience to the user. As used herein, “CAP experience” and “experience” are used interchangeably and intended to mean the interpretation of multiple elements of context in the right order and in real-time to provide information to a user in a seamless, integrated, and holistic fashion. In some examples, an experience or CAP experience can be provided by executing instructions on a processing resource at a computing node. Further, an “object” can include anything that is visible or tangible, for example, a machine, a device, and/or a substance.

The CAP experience is created through the interpretation of one or more packages. Packages can be atomic components that execute functions related to devices or integrations to other systems. As used herein, “package” is intended to mean components that capture individual elements of context in a given situation. In some examples, the execution of packages provides an experience. For example, a package could provide a schedule or a navigation component, and an experience could be provided by executing a schedule package to determine a user's schedule, and subsequently executing a navigation package to guide a user to the location of an event or task on the user's schedule. As another example, another experience could be provided by executing a facial recognition package to identify a face in an image by comparing selected facial features from the image with data stored in a facial database.

In some examples, the platform includes one or more experiences, each of which correspond to a particular application, such as a user's occupation or a robot's purpose. In addition, the example platform may include a plurality of packages which are accessed by the various experiences. The packages may, in turn, access various information from a user or other resources and may call various services, as described in greater detail below. As a result, the user can be provided with contextual information seamlessly with little or no input from the user. The CAP is an integrated ecosystem that can bring context to information automatically and “in the moment.” For example, CAP can sense, retrieve, and provide information from a plurality of disparate sensors, devices, and/or technologies, in context, and without input from a user.

Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

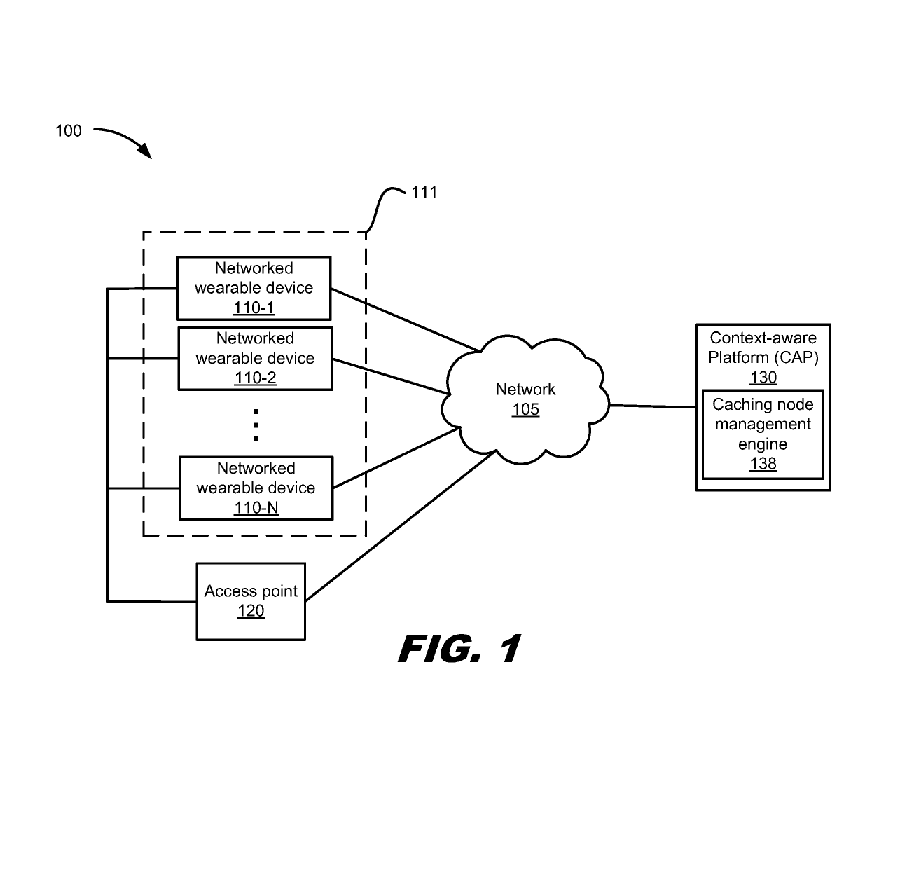

FIG. 1 depicts an example environment in which a context-aware platform (CAP) 130 may be implemented, where the CAP 130 includes a caching node management engine 138 for managing caching of data at remote caching nodes.

Wearable devices can include any number of portable devices associated with a user of the devices that have a processor and memory and are capable of communicating wirelessly by using a wireless protocol, such as WiFi or Bluetooth. Examples of wearable devices include a smartphone, laptop, smart watch, electronic key fob, smart glass, and any other device or sensor that can be attached to or worn by a user. When a user's wearable devices are configured to communicate with each other, for example, as indicated by wearable device communication network 111 in FIG. 1, the devices are referred to herein as networked wearable devices (NWDs) 110.

Access point 120 can be a standalone access point device; however, examples are not so limited, and access point 120 can be embedded in a stationary device, for example, a printer, a point of sale device, etc. The access point 120 can include a processor and memory configured to communicate with the device in which it is embedded and to communicate with the CAP 130 and/or networked wearable devices 110 within wireless communication range. While only one access point 120 is shown in the example of FIG. 1 for clarity, multiple access points can be located within wireless communication range of the one or more NWDs associated with a user.

A caching node used for caching data for a package to provide an experience to a user can reside at a NWD 110 associated with that user or at an access point 120 within wireless communication range of the user's NWDs 110. Each caching node includes components, to be described below, that support caching data for the experience by using the available storage resources of the NWD 110 or access point 120.

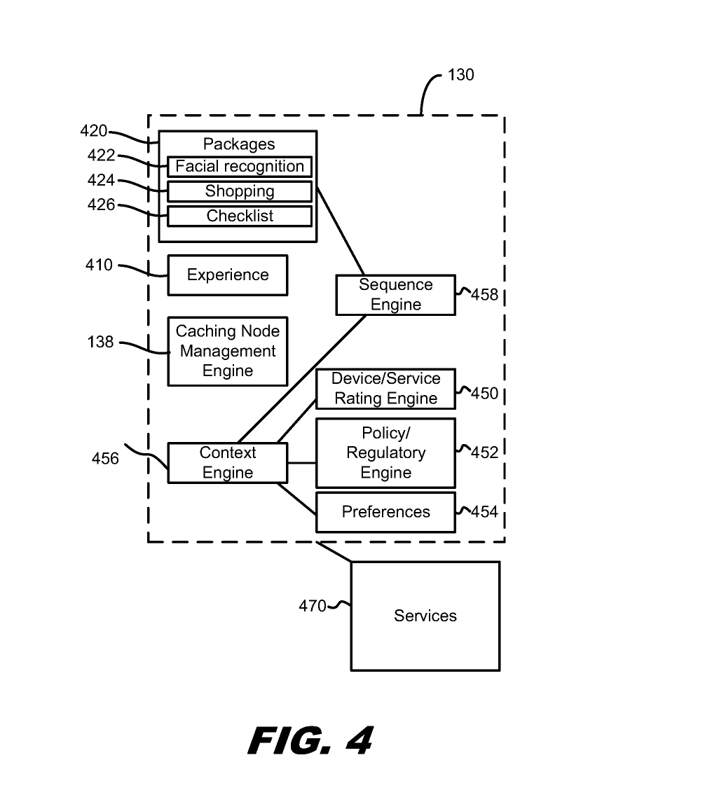

In the example of FIG. 1, the CAP 130 can communicate through a network 105 with one or more of the caching nodes at the NWDs 110 and/or a caching node at the access point 120. The network 105 can be any type of network, such as the Internet, or an intranet. The CAP 130 includes a caching node management engine 138, among other components to be described below with reference to FIG. 4. The caching node management engine 138 supports the selection and remote management of caching nodes in close proximity to the user to provide access to data to support providing an experience to the user. The experience can be user-initiated or automatically performed

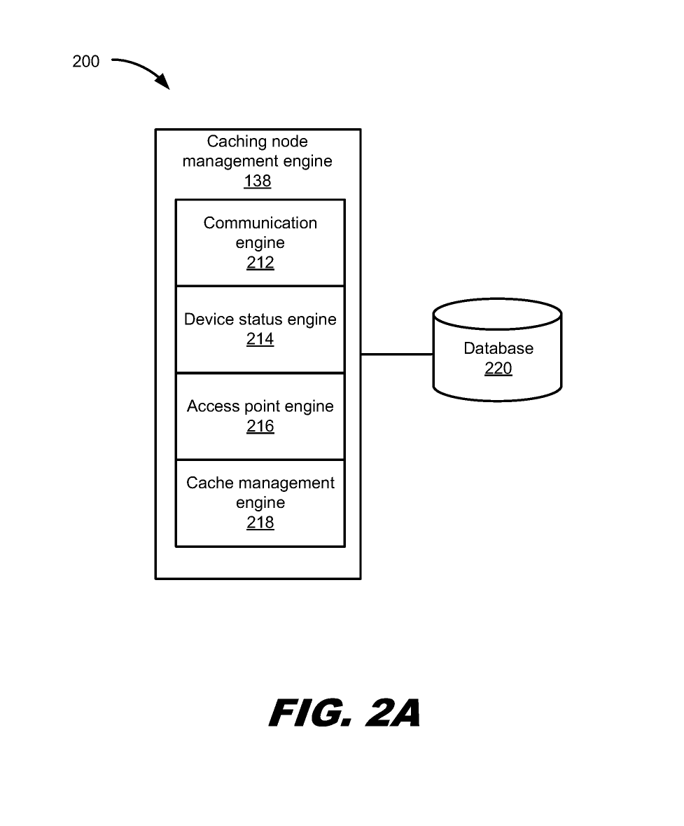

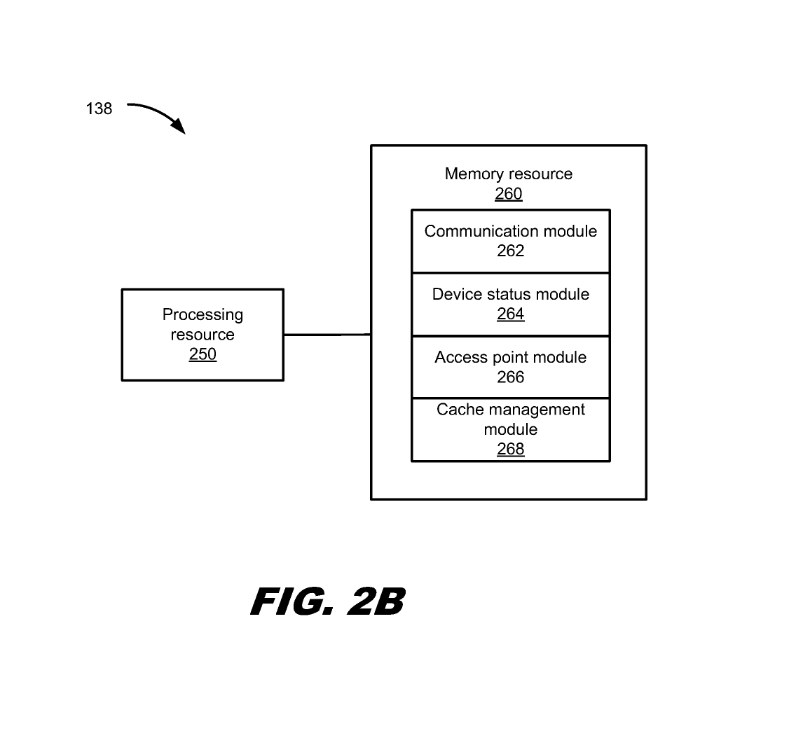

FIG. 2A depicts a block diagram 200 including example components of a caching node management engine 138. The caching node management engine 138 can include a communication engine 212, a device status engine 214, an access point engine 216, and a cache management engine 218. Each of the engines 212, 214, 216, 218 can access and be in communication with a database 220.

Communication engine 212 may be configured to receive notification of data to be cached as requested by a package for providing an experience to a user.

The device status engine 214 may be configured to register and identify caching nodes at NWDs 110 associated with a user. When data is to be cached to support an experience to be provided to a particular user, the device status engine 214 can determine available storage resources at the caching nodes at each NWD 110 associated with the user and select one or more of the caching nodes to cache portions of the data.

The access point engine 216 may be configured to register and identify access points. Registration information can include a location identifier, such as global positioning (GPS) coordinates. Upon receiving notification of data to be cached for a package for providing an experience to a user, the access point engine 216 may identify one or more suitable access points within wireless communication range of the NWDs 110 associated with the user based on the location of the user. The access point engine 216 can communicate with the appropriately located access points to determine available storage resources at the respective access points and select one or more access points to cache portions of the data.

The cache management engine 218 may be configured to transmit portions of the data to be cached to one or more caching nodes that reside at a NWD 110. For example, the caching nodes at the NWDs 110 can be used exclusively in a situation when the user is not near any access points, such as when the user is outside.

If the user is near one or more access points 120, for example, inside an office building with caching nodes located at printers or a shopping complex with caching nodes located at point of sale devices, the cache management engine 218 can transmit requests to an access point 120 in close proximity to the user and the user's NWDs 110 to cache portions of the data in addition to, or instead of, at the caching nodes at the NWDs 110. The cache management engine 218 can also transmit to the package requesting caching of the data the location information for the different portions of the data cached at each of the one or more caching nodes at the NWDs 110 and/or the access points 120.

In some instances, the package requesting caching of the data will send an indication that the task using the cached data has been completed, or that the cached data is no longer needed. Then the cache management engine 218 can inform the selected caching nodes that the cached data can be overwritten or deleted from the respective memories.

Database 220 can store data, such as registration information for the NWDs 110 and access points 120.

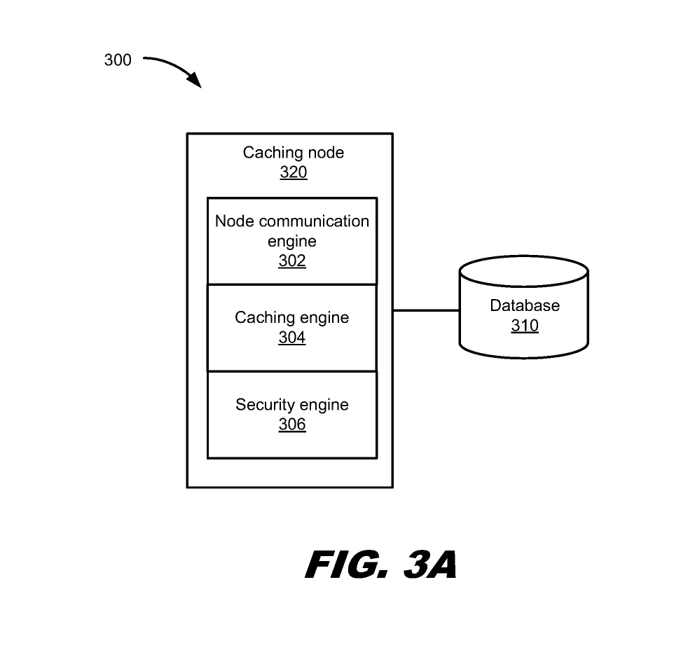

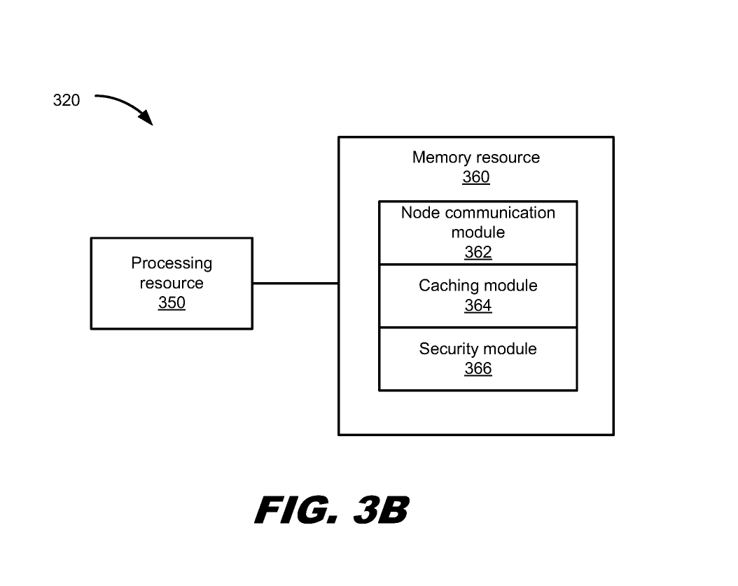

FIG. 3A depicts a block diagram of example components of a caching node residing at a NWD 110 or access point 120. The caching node can include a node communication engine 302, a caching engine 304, and a security engine 306. Each of engines 302, 304, 306 can interact with a database 310.

Node communication engine 302 may be configured to receive the portion of the data to be cached at the caching node and acknowledge receipt of the data for caching.

The caching engine 304 may be configured to cache the data at a storage resource at the node and respond to requests for cached data.

The security engine 306 may be configured to receive and use authentication information to be used for requests for cached data. Examples of authentication information can include identification information for the package or packages to be allowed to access the data cached at the caching node and a password to be provided with a request for cached data. For example, the security engine 306 can be configured to reject a request for cached data from unauthorized requestors, and allow the caching engine 304 to respond to the request for cached data if the request originates from a previously authorized package. As another example, the security engine 306 can reject a request for cached data if the request includes incorrect passwords, and allow the caching engine 304 to provide the cached data if the request includes a password associated with the cached data, and. The security engine 306 can also be configured to implement different or more stringent security measures for cached data.

Database 310 can store data, such as authentication information for cached data.

The examples of engines shown in FIGS. 2A and 3A are not limiting, as one or more engines described can be combined or be a sub-engine of another engine. Further, the engines shown can be remote from one another in a distributed computing environment, cloud computing environment, etc.

In the above description, various components were described as combinations of hardware and programming. Such components may be implemented in different ways. Referring to FIG. 2B, the programming may be processor executable instructions stored on tangible memory resource 260 and the hardware may include processing resource 250 for executing those instructions. Thus, memory resource 260 can store program instructions that when executed by processing resource 250, implements caching node management engine 138 of FIG. 2A. Similarly, referring to FIG. 3B, the programming may be processor executable instructions stored on tangible memory resource 360 and the hardware may include processing resource 350 for executing those instructions. So memory resource 360 can store program instructions that when executed by processing resource 350, implements the caching node portion of NWD 110 or access point 120 of FIG. 3A.

Memory resource 260 generally represents any number of memory components capable of storing instructions that can be executed by processing resource 250. Similarly, memory resource 360 generally represents any number of memory components capable of storing instructions that can be executed by processing resource 350. Memory resource 260, 360 is non-transitory in the sense that it does not encompass a transitory signal but instead is made up of one or more memory components configured to store the relevant instructions. Memory resource 260, 360 may be implemented in a single device or distributed across devices. Likewise, processing resource 250 represents any number of processors capable of executing instructions stored by memory resource 260, and similarly for processing resource 350 and memory resource 360. Processing resource 250, 350 may be integrated in a single device or distributed across devices. Further, memory resource 260 may be fully or partially integrated in the same device as processing resource 250, or it may be separate but accessible to that device and processing resource 250, and similarly for memory resource 360 and processing resource 350.

In one example, the program instructions can be part of an installation package that when installed can be executed by processing resource 250 to implement caching node management engine 138 or by processing resource 350 to implement the caching node portion of a NWD 110 or access point 120. In this case, memory resource 260, 360 may be a portable medium such as a compact disc (CD), digital video disc (DVD), or flash drive or a memory maintained by a server from which the installation package can be downloaded and installed. In another example, the program instructions may be part of an application or applications already installed. Memory resource 260, 360 can include integrated memory, such as a hard drive, solid state drive, or the like.

In the example of FIG. 2B, the executable program instructions stored in memory resource 260 are depicted as communication module 262, device status module 264, access point module 266, and cache management module 268. Communication module 262 represents program instructions that when executed cause processing resource 250 to implement communication engine 212. Device status module 264 represents program instructions that when executed cause processing resource 250 to implement device status engine 214. Access point module 266 represents program instructions that when executed cause processing resource 250 to implement access point engine 216. Cache management module 268 represents program instructions that when executed cause processing resource 250 to implement cache management engine 218.

In the example of FIG. 3B, the executable program instructions stored in memory resource 360 are depicted as node communication module 362, caching module 364, and security module 366. Node communication module 362 represents program instructions that when executed cause processing resource 350 to implement node communication engine 302. Caching module 364 represents program instructions that when executed cause processing resource 350 to implement caching engine 304. Security module 366 represents program instructions that when executed cause processing resource 350 to implement security engine 306.

FIG. 4 depicts a block diagram of an example context-aware platform (CAP) 130. The CAP 130 may determine which package among multiple available packages 420 to execute based on information provided by the context engine 456 and the sequence engine 458. In some examples, the context engine 456 can be provided with information from a device/service rating engine 450, a policy/regulatory engine 452, and/or preferences 454. For example, the context engine 456 can determine what package to execute based on a device/service rating engine 450 (e.g., hardware and/or program instructions that can provide a rating for devices and/or services based on whether or not a device can adequately perform the requested function), a policy/regulatory engine 452 (e.g., hardware and/or program instructions that can provide a rating based on policies and/or regulations), preferences 454 (e.g., preferences created by a user), or any combination thereof. In addition, the sequence engine 458 can communicate with the context engine 456 to identify packages 420 to execute, and to determine an order of execution for the packages 420. In some examples, the context engine 456 can obtain information from the device/service rating engine 450, the policy/regulatory engine 452, and/or preferences 454 automatically (e.g., without any input from a user) and can determine what package 420 to execute automatically (e.g., without any input from a user). In addition, the context engine 456 can determine what package 420 to execute based on the sequence engine 458.

For example, based on information provided to the CAP system 130 from the context engine 456, the sequence engine 458, and the device/service rating engine 450, the experience 410 may call a facial recognition package 422 to perform facial recognition on a digital image of a person's face. In some examples, the experience 410 can be initiated by voice and/or gestures received by a NWD 110 which communicates with the CAP system 130 via network 105 (as shown in FIG. 1) to call the facial recognition package 422, as described above. Alternatively, in some examples, the facial recognition package 422 can be automatically called by the experience 410 at a particular time of day, for example, 10:00 pm, the time scheduled for a meeting with a person whose identity should be confirmed by facial recognition. In addition, the facial recognition package 422 can be called upon determination by the experience 410 that a specific action has been completed, for example, after a digital image has been captured by a digital camera on the NWD 110, such as can be found on a smartphone. Thus, in various examples, the facial recognition package 422 can be called by the experience 410 without any input from the user. Similarly, other packages 420 that may need the performance of computationally intensive tasks can be called by the experience 410 without any input from the user.

As an example, processing of a task, such as a facial recognition task, can be performed at computing nodes that reside at one or more NWDs 110 associated with the user and/or access points within wireless communication range of the NWDs 110 associated with the user. By selecting computing nodes at the NWDs 110 associated with the user to whom the experience 410 will be provided and access points 120 within close proximity of the NWDs 110, quicker responses to the computationally intense task are obtained in providing the experience 410 to the user because latency in the process is minimized. In contrast, for example, in a centralized computation model in the cloud, the latency in the process can significantly delay the computations.

The storage resources of multiple NWDs and access points near the computing nodes can be used as caching nodes for data needed by a processing task to increase the speed at which the task is performed, such as the facial recognition task. When facial recognition package 422 is executed, it triggers the caching node management engine 138 to call the services 470 to retrieve facial recognition information and/or metadata needed for performing the facial recognition task. The facial recognition information and/or metadata is then transmitted by the caching node management engine 138 via network 105 to the caching nodes selected to cache the information and/or metadata.

Caching data for the facial recognition package 422 is one example in which data can be cached at caching nodes near where a processing task is being performed for a particular user. Other packages can also cache data at caching nodes near computing nodes to speed up a processing task. For example, a user can initiate a shopping experience that may provide a listing of current sales in the store in which the user is located. The shopping experience is provided by a shopping package 424, and the shopping package 424 can trigger the caching node management engine 138 to call services 470 to retrieve shopping and/or marketing information, such as current sales and advertisements related to the sales. In this example, in addition to caching the shopping and/or marketing information at caching nodes of NWDs associated with the user, the caching node management engine 138 can select a caching node residing at a local point of sale device for caching additional information that might not be capable of being stored at the caching nodes of the NWDs due to limitations in storage resources at the NWDs.

As another example, a checklist package 426 can trigger the caching node management engine 138 to call services 470 to retrieve checklist information, such as used in a service technician's call with multiple actions to be performed on different devices. In this example, in addition to caching the checklist information at caching nodes of NWDs associated with the user, the caching node management engine 138 can select a caching node residing at a local printer for caching additional information that might not be capable of being stored at the caching nodes of the NWDs due to limitations in storage resources at the NWDs.

Although caching resources may be limited at a user's NWDs 110, use of other local caching nodes allow the user to operate essentially in a hands-free mode. Thus, while a user may have a laptop device that has sufficient storage resources to cache any information to be used in a processing task for a package, the user may not want to carry the laptop device and merely rely on the memory available in a smart watch attached to the user's wrist and a smartphone carried on the user's belt for storage resources. Data to be cached that does not fit on the memory resources of the smart watch and smart phone may be cached at a local caching node, such as a printer or point of sale device.

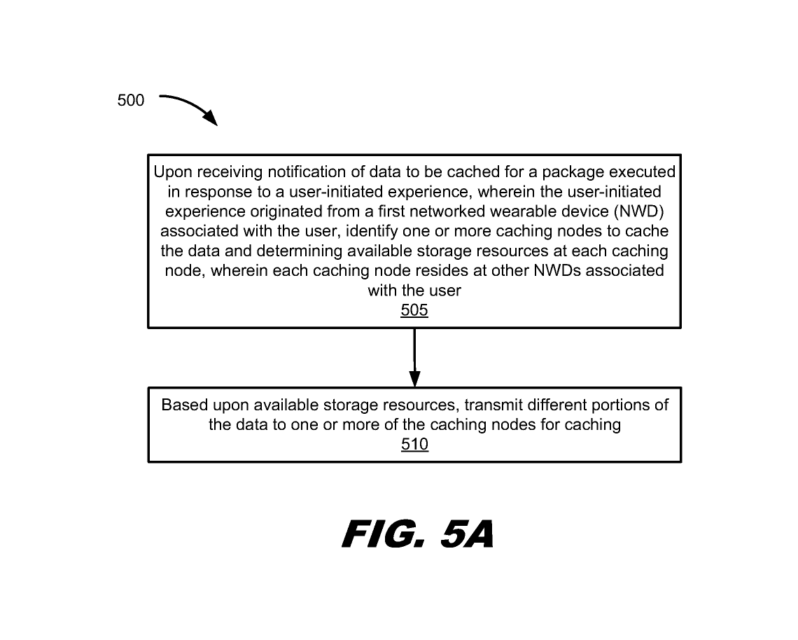

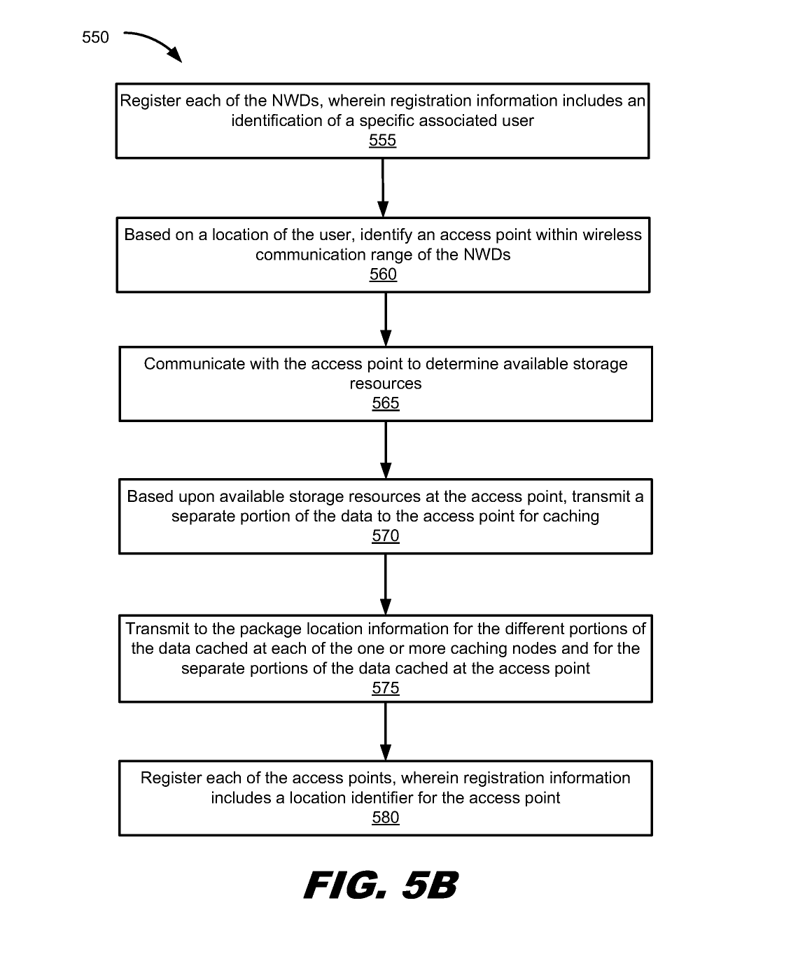

FIG. 5A depicts a flow diagram illustrating an example process 500 of identifying and selecting one or more caching nodes at a networked wearable device for caching data for use by a package for providing a user experience.

At block 505, upon receiving notification of data to be cached for a package executed in response to a user-initiated experience, where the user-initiated experience originated from a first networked wearable device (NWD) associated with the user, the caching node management engine identifies one or more caching nodes to cache the data and determines available storage resources at each caching node. The notification for caching of data for the package can include the user who will be provided the experience and a current location of the user. Each caching node resides at other NWDs associated with the user or access points; thus the selected caching nodes are in close proximity to the user.

At block 510, based upon available storage resources, the caching node management engine transmits different portions of the data to one or more of the caching nodes for caching. In some instances, the caching node of the first NWD can also cache a portion of the data in the memory resources of the local NWD.

FIG. 5B depicts a flow diagram illustrating an example process 550 of registering networked wearable devices and selecting an access node for caching additional data for use by the package.

At block 555, the caching node management engine registers each of the NWDs, where registration information obtained during registration includes an identification of a specific associated user.

Then at block 560, the caching node management engine identifies an access point within wireless communication range of the NWDs based on a location of the user. Next, at block 565, the caching node management engine communicates with the access point to determine available storage resources.

At block 570, the caching node management engine, based upon available storage resources at the access point, transmits a separate portion of the data to the access point for caching.

At block 575, the caching node management engine transmits to the package location information for the different portions of the data cached at each of the one or more caching nodes and for the separate portions of the data cached at the access point.

Then at block 580, the caching node management engine registers each of the access points, where registration information obtained during registration includes a location identifier for the access point.

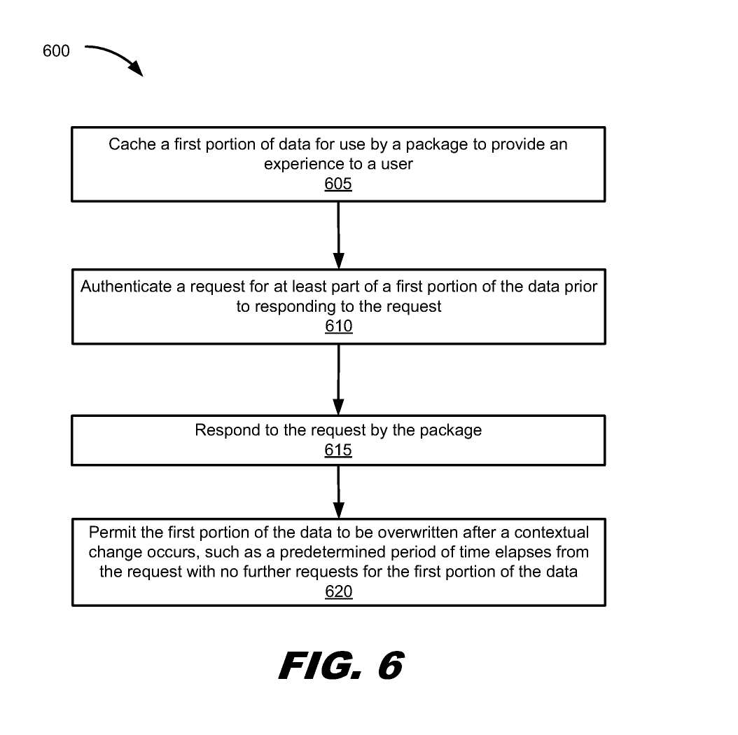

FIG. 6 depicts a flow diagram illustrating an example process 600 of caching data at a caching node.

At block 605, the caching node receives and caches a first portion of data for use by a package to provide an experience to a user. The caching node resides at a networked wearable device of the user.

Then at block 610, the caching node authenticates a request for at least a part of the first portion of the data prior to responding to the request. At block 615, the caching node responds to the request by the package by retrieving the first portion of the requested data.

Next, at block 620, the caching node permits the first portion of the data to be overwritten after a contextual change occurs, such as a predetermined period of time elapses from the request with no further requests for the first portion of the data. Alternatively, the caching node can store the first portion of the data until directed by the caching node management engine to discard the first portion of the data, for example, upon completion of the task for which the data was cached.

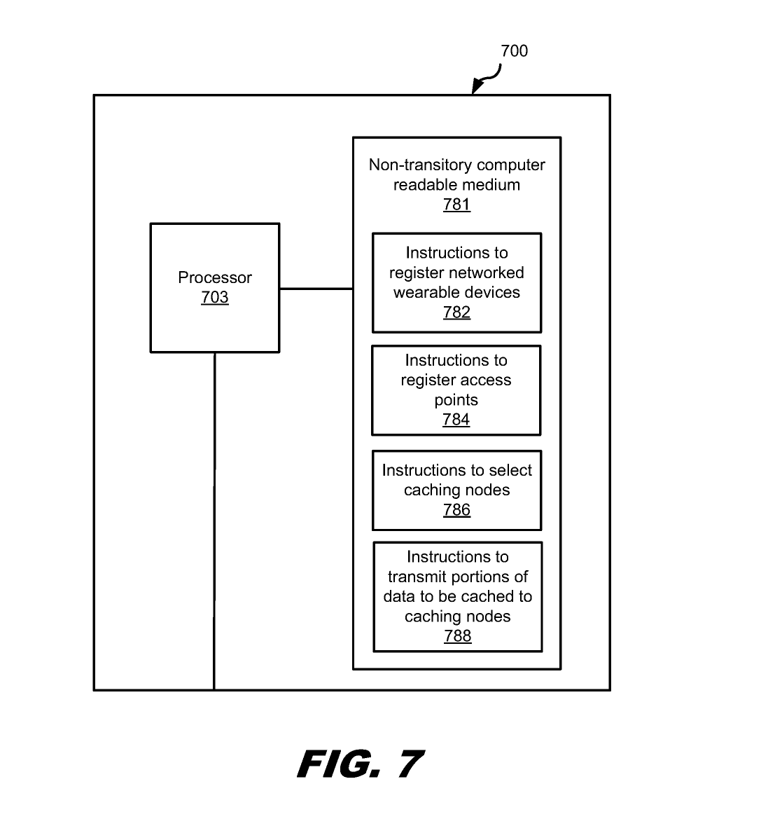

FIG. 7 illustrates an example system 700 including a processor 703 and non-transitory computer readable medium 781 according to the present disclosure. For example, the system 700 can be an implementation of an example system such as caching node management engine 138 of FIG. 2A.

The processor 703 can be configured to execute instructions stored on the non-transitory computer readable medium 781. For example, the non-transitory computer readable medium 781 can be any type of volatile or non-volatile memory or storage, such as random access memory (RAM), flash memory, or a hard disk. When executed, the instructions can cause the processor 703 to perform a method of selecting one or more caching nodes to cache data for use by a package to provide an experience to a user.

The example medium 781 can store instructions executable by the processor 703 to perform remote management of caching nodes. For example, the processor 703 can execute instructions 782 to register NWDs associated with a user and determine the available storage resources at the NWDs. In addition, the processor 703 can execute instructions 782 to perform blocks 565 and 580 of the method of FIG. 5B.

The example medium 781 can further store instructions 784. The instructions 784 can be executable to register access points capable of caching data requested by a package and determine the available storage resources at the access points. In addition, the processor 703 can execute instructions 784 to perform block 505 of the method of FIG. 5A and block 555 of FIG. 5B.

The example medium 781 can further store instructions 786. The instructions 786 can be executable to select one or more of the caching nodes for caching data for use by a package to provide an experience to a user.

The example medium 781 can further store instructions 788. The instructions 788 can be executable to transmit portions of data to be cached to one or more caching nodes. In addition, the processor 703 can execute instructions 788 to perform block 510 of the method of FIG. 5A.

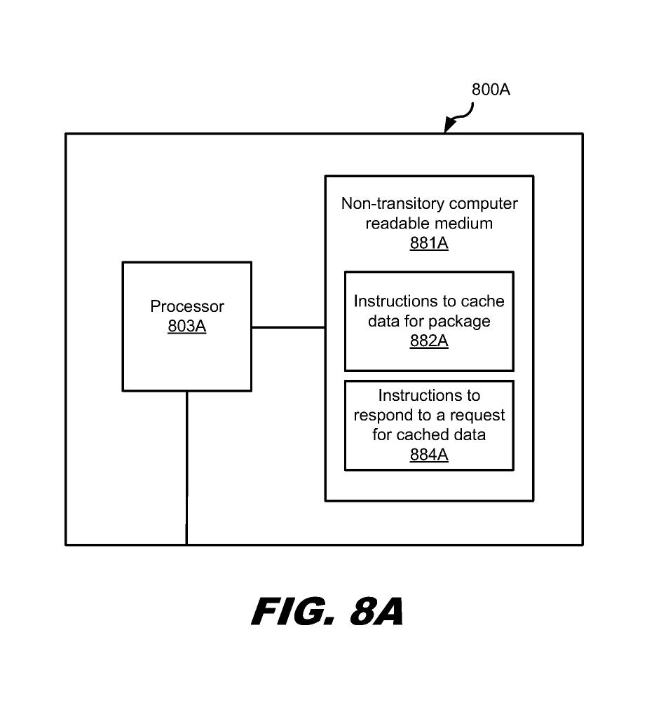

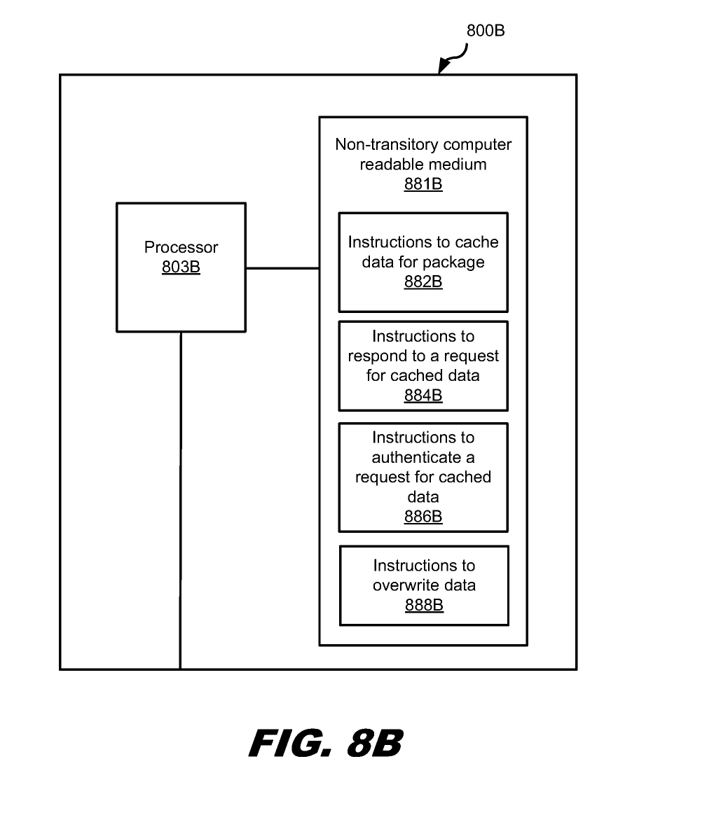

FIG. 8A illustrates an example system 800A including a processor 803A and non-transitory computer readable medium 881A according to the present disclosure. For example, the system 800A can be an implementation of an example system such as a caching node 320 of FIG. 3A residing at a NWD 110 or access point 120.

The processor 803A can be configured to execute instructions stored on the non-transitory computer readable medium 881A. For example, the non-transitory computer readable medium 881A can be any type of volatile or non-volatile memory or storage, such as random access memory (RAM), flash memory, or a hard disk. When executed, the instructions can cause the processor 803 to perform a method of caching data for use by a package to provide an experience to a user.

The example medium 881A can store instructions executable by the processor 803A to cache data at a computing node, such as the method described with respect to FIG. 6. For example, the processor 803A can execute instructions 882A to cache data for a package. In addition, the processor 803A can execute instructions 882A to perform block 605 of the method of FIG. 6.

The example medium 881A can further store instructions 884A. The instructions 884A can be executable to respond to a request for cached data. Additionally, the processor 803A can execute instructions 884A to perform block 615, of the method of FIG. 6.

FIG. 8B illustrates an example system 800B including a processor 803B and non-transitory computer readable medium 881B according to the present disclosure. For example, the system 800B can be another implementation of an example system such as a caching node 320 of FIG. 3A residing at a NWD 110 or access point 120.

The processor 803B can be configured to execute instructions stored on the non-transitory computer readable medium 881B. For example, the non-transitory computer readable medium 881B can be any type of volatile or non-volatile memory or storage, such as random access memory (RAM), flash memory, or a hard disk. When executed, the instructions can cause the processor 803B to perform a method of caching data for use by a package to provide an experience to a user.

Similar to the example of FIG. 8A, the example medium 881B can store instructions executable by the processor 803B to cache data at a computing node, such as the method described with respect to FIG. 6. For example, the processor 803B can execute instructions 882B to cache data for a package, and instructions 884B can be executable to respond to a request for cached data.

The example medium 881B can further store instructions 886B. The instructions 886B can be executable to authenticate a request for cached data. In addition, the processor 803B can execute instructions 886B to perform block 610 of the method of FIG. 6.

The example medium 881B can further store instructions 888B. The instructions 888B can be executable to overwrite cached data. In addition, the processor 803B can execute instructions 888B to perform block 620 of the method of FIG. 6.

Not all of the steps, features, or instructions presented above are used in each implementation of the presented techniques.

What is claimed is:

1. A system comprising:
a communication engine to receive notification of data to be cached for a package to provide an experience to a user;
a device status engine to determine one or more caching nodes for caching the data, wherein each caching node resides at a networked wearable device (NWD) associated with the user; and
a cache management engine to transmit different portions of the data to the one or more caching nodes for caching.

2. The system of claim 1, further comprising:
an access point engine to determine one or more additional caching nodes for caching the data,
wherein each additional caching node resides at an access point, and each access point is within wireless communication range of the NWDs, and
wherein the cache management engine further transmits additional portions of the data to each of the one or more additional caching nodes for caching.

3. The system of claim 2, wherein the access point engine is further to register each of the access points, wherein registration information includes a location identifier for the access point.

4. The system of claim 1, wherein the communication engine further transmits to the package location information for the different portions of the data and the additional portions of the data.

5. The system of claim 1, wherein the device status engine is further to register each of the NWDs, wherein registration information includes identification of a specific associated user.

6. A method comprising:
upon receiving notification of data to be cached for a package executed in response to a user-initiated experience, wherein the user-initiated experience originated from a first networked wearable device (NWD) associated with the user, identifying one or more caching nodes to cache the data and determining available storage resources at each caching node, wherein each caching node resides at other NWDs associated with the user; and
based upon available storage resources, transmitting different portions of the data to the one or more of the caching nodes for caching.

7. The method of claim 6, further comprising:
registering each of the NWDs, wherein registration information includes an identification of a specific associated user.

8. The method of claim 6, further comprising:
based on a location of the user, identifying an access point within wireless communication range of the NWDs;
communicating with the access point to determine available storage resources; and
based upon available storage resources at the access point, transmitting a separate portion of the data to the access point for caching.

9. The method of claim 8, further comprising transmitting to the package location information for the different portions of the data cached at each of the one or more caching nodes and for the separate portions of the data cached at the access point.

10. The method of claim 9, further comprising registering each of the access points, wherein registration information includes a location identifier for the access point.

11. The method of claim 9, wherein the access point is embedded in at least one of: a printer and a point of sale device.

12. A non-transitory computer readable medium storing instructions executable by a processing resource of a caching node to:
cache a first portion of data for use by a package to provide an experience to a user; and
respond to a request by the package for at least a part of the first portion of the data,
wherein the caching node resides at a networked wearable device of the user.

13. The non-transitory computer readable medium of claim 12, wherein the stored instructions further cause the processing resource to:
authenticate the request for the at least a part of the first portion of the data prior to responding to the request.

14. The non-transitory computer readable medium of claim 12, wherein the stored instructions further cause the processing resource to:
permit the first portion of the data to be overwritten after a contextual change occurs.

15. The non-transitory computer readable medium of claim 12, wherein a different portion of the data is cached at an access point embedded in at least one of: a printer and a point of sale device.
